(19) United States
(12) Patent Application Publication
(10) Pub. No.: US 2009/0140212 A1
(43) Pub. Date: Jun. 4, 2009

(54) Electron Transfer Through Glassy Matrices

(76) Inventors: Joel M. Friedman, South Orange, NJ (US); Mahantesh S. Navati, Bronx, NY (US)

Correspondence Address: AMSTER, ROTHSTEIN & EBENSTEIN LLP, 90 PARK AVENUE, NEW YORK, NY, 10016, US

(21) Appl. No.: 12/223,762

(22) PCT Filed: Feb. 21, 2007
(86) PCT No.: PCT/US2007/004611

§ 371 Date: Dec. 5, 2008

Related U.S. Application Data
(60) Provisional application No. 60/776,513, filed on Feb. 24, 2006.

(51) Int. Cl. H01B 1/12; H01B 1/02; H01B 1/00

(52) U.S. Cl. 252/501.1; 252/500; 252/519.21

(57) ABSTRACT

Provided are electron transfer compositions comprising a glassy sugar matrix. Electric batteries, electric circuits, semiconductors, solar cells, thermal detectors, and photo detectors comprising glassy sugar matrices are also provided. Additionally provided are methods of transferring electrons to a redox protein using these compositions.

### CROSS-REFERENCE TO RELATED APPLICATION

This application claims the benefit of U.S. Provisional Application No. 60/776,513, filed Feb. 24, 2006.

### BACKGROUND OF THE INVENTION

(1) Field of the Invention

The present invention generally relates to electron transfer compositions. More specifically, the invention is directed to electron transfer compositions comprising glassy sugar matrices, and methods for using those compositions.

(2) Description of the Related Art

Proteins have extraordinary potential as biomaterials. They present with a vast array of functionalities that can be systematically tuned through mutagenesis, chemical modifications and environment. Unfortunately, the promise of exciting new protein-based technologies (Gopel and Heiduschka, 1994; Davus, 2003; Willner and Willner, 2001) is significantly thwarted by both intrinsic instability and stringent solvent/environment requirements for the expression of functional properties. Redox proteins are a case in point. As a group, they not only exhibit a very broad and tunable range of redox potentials but also manifest coupled functions that together would be technologically useful. The ability to use these proteins in solid-state nano-electronic devices such as tunable batteries, switches and solar cells is constrained due to the above noted limitations.

Many plants and animals express large amounts of sugars when osmotically stressed (Arguelles, 2000). The ability of sugars such as trehalose to form glassy matrices under conditions of severe drying is generally thought to be responsible for anhydrobiosis (Crowe et al., 1992; 1998), whereby the cellular machinery is essentially frozen in the glass allowing for long term survival under conditions of extreme dryness. This phenomenon is the basis for substantial efforts directed toward the creation of suitable carbohydrate-based glassy matrices for the purpose of long term preservation of pharmaceuticals and food items. Biophysical studies show that the glassy matrix significantly damps protein motions (Hagen et al., 1995; Gottfried et al., 1996; Cordone et al., 1998; Sastry and Agmon, 1997; Dantzker et al., 2005), which results in dramatic conformational stabilization with respect to thermal denaturation and degradation. Thus sugar-derived glasses should provide a matrix for long-term maintenance of proteins under relatively severe conditions.

Both the damping of macromolccular dynamics and the dramatic decrease in the mobility of water within sugar-derived glasses are viewed as the foundation for designing stable sugar-based matrices for long-term maintenance of proteins and other biomolecules under relatively severe conditions. Under such conditions it is assumed that the matrix would be chemically inert. In the present study it is demonstrated that dry glassy matrices can support very long range electron transfer initiated by generating either thermal or photo electrons.

Most proteins when incorporated into glassy matrices can no longer function due to the extreme damping of many functionally important motions. Redox reactions, although influenced by protein dynamics, can still occur even when the proteins are immobilized. Ray et al. (2002) showed that doping glasses containing either methemoglobin or metmyoglobin with glucose (a reducing sugar) results in samples that undergo facile thermal reduction.

Further characterization of the ability of redox proteins to undergo reduction in sugar glass, and development of practical uses of this phenomenon is needed. The present invention addresses those needs.

### SUMMARY OF THE INVENTION

Accordingly, the inventors have discovered that electrons are capable of flowing over long distances through glassy sugar matrices to reduce redox proteins embedded in the matrix. These glassy sugar matrices, with or without embedded redox proteins, can thus be used in various electronic and energy-storing devices.

Thus, the present invention is directed to electron transfer compositions comprising a first matrix and a second matrix. In these compositions, the first matrix is a glassy sugar matrix, and the second matrix contacts the first matrix and is capable of providing electrons to the first matrix.

The invention is also directed to electron transfer compositions comprising a first matrix and a second matrix. In these compositions, the first matrix is a glassy sugar matrix, and the second matrix contacts the first matrix and is capable of receiving electrons from the first matrix.

Additionally, the invention is directed to electric batteries comprising any of the above electron transfer compositions.

The invention is further directed to electric circuits comprising any of the above electron transfer compositions.

The invention is additionally directed to semiconductors comprising any of the above electron transfer compositions.

Also, the invention is directed to solar cells comprising any of the above electron transfer compositions.

The invention is also directed to thermal detectors comprising any of the above electron transfer compositions.

Further, the invention is directed to photo detectors comprising any of the above electron transfer compositions.

Additionally, the invention is directed to methods of transferring electrons to a redox protein. The methods comprise preparing any of the above compositions, where the composition further comprises a redox protein in the glassy sugar matrix, then subjecting the composition to a reducing condition.

### BRIEF DESCRIPTION OF THE DRAWINGS

FIG. 1 shows absorption spectra showing changes in the absorption spectrum of glass-embedded aquomet myoglobin (Mb), aquomet human adult hemoglobin (Hb), and cytochrome c (Cc) as a function of heating. The three panels on the left and on the right show the heating induced changes for samples embedded in glassy matrices without (Mb, Hb and Cc) and with (Mb*, Hb* and Cc*) added reducing sugar, respectively. The heating protocols were as follows:

| | | | |
|---|---|---|---|
| Mb, Mb*: | a) before heating | b) 67° C., 4 hrs | c) 65° C., 3 days |
| Hb, Hb* | a) before heating | b) 75° C., 2 hrs | c) 85° C., 45 min |
| Cc, Cc* | a) before heating | b) 40° C., 45 min | c) 60° C., 45 min |

The insert in the top two panels on the left shows the appearance with heating of Band III, which is exclusively associated with reduced forms of Hb and Mb.

FIG. 2 shows spectra of single layer glassy samples of aquomet HbA subsequent to heating (65° C. for 45 minutes) as a function of added additional sugars (glucose, fructose and tagatose) included in the glass-forming trehalose/sucrose mixture.

FIG. 3 shows changes in the absorption spectra as a function of heating for glucose-doped glasses with embedded Mb(H64L) shown in Panel A and Mb(H64Q) shown in Panel B.

FIG. 4 shows changes in the absorption spectrum of aquomet HbA embedded in a trehalose/sucrose glass (Glass 2) doped with both glucose and glycerol.

FIG. 5 shows changes as a function of illumination time at ambient temperature in the absorption spectrum for aquomet HbA in a deazaflavin-doped trehalose/sucrose/tagatose single thin layer glassy matrix. The initial, intermediate and final spectra are shown.

FIG. 6 shows absorption spectra demonstrating thermal and light mediated reduction of glass embedded aquomet human adult hemoglobin (HbA) in a two layer sandwich configuration. In the top panel, the Hb containing layer is joined with a glucose containing protein-free layer and then heated. The black trace is from the sample where both layers are separately preheated at 40° C. for 45 minutes and then combined. The red trace is from the sample after the combined two layers undergoes heating at 75° C. for 45 min. The bottom panel shows the light induced absorption changes for a sandwich in which the non-Hb containing glass contains deazaflavin. The black and red traced are from the glassy Hb sample before and after 3 hour illumination with low intensity light at 390 nm.

FIG. 7 shows the absorption spectra subsequent to heating at 70° C. for one hour of a sample of aquomet HbA embedded in a trehalose/sucrose glassy layer sandwiched with different protein-free glass samples. The results are shown from samples using four different protein-free layers: trehalose/sucrose (control), trehalose/sucrose/glucose, trehalose/sucrose/fructose and trehalose/sucrose/tagatose.

FIG. 8 shows the absorption spectra of separated glassy layers of aquomet HbA and oxidized Cc before and after the two layers are sandwiched together, heated (50° C. for 45 min.) and then re-separated. Both proteins were embedded in a trehalose/sucrose glass with any additional sugars or additives.

FIG. 9 shows changes in the visible absorption spectra of oxidized hemeproteins. In both the upper and lower panels, the hemeprotein containing layer is linked via a dopant-free trehalose/sucrose glassy strip to an electron source (see schematic on top of the figure). In the upper panel, the changes in the spectrum of oxidized cytochrome c are shown before (black) and after (blue) illumination of an FMN/NADPH doped layer. The insert shows the corresponding changes in the FMN spectrum that indicate the light induced change in redox status of the FMN. The bottom panel shows heat induced changes in the absorption spectrum of aquomet HbA linked to a tagatose (tag) doped-glassy film. The first intermediate spectrum has a large contribution from the hemichrome whereas the final spectrum is reflective of the hemochrome.

### DETAILED DESCRIPTION OF THE INVENTION

The inventors have discovered that glassy matrices derived from certain sugars support electron transfer over large distances. These matrices can therefore be used as an electron-conducting material and can usefully interface with other conductors and semiconductors. Proteins incorporated into these glassy matrices are stable with respect to extreme heating. When the glass includes both redox proteins and a reducing sugar, the heating of the glass results in release of electrons by the reducing sugar, which can in turn reduce proteins in the same or adjacent glassy layers. Similarly the glass will support long-range transfer of photo-ejected electrons. See Example. Thus, by using suitable redox proteins to efficiently harvest either thermal or photo generated electrons, these glassy matrices can be used as batteries that can be interfaced with solid state semiconductor devices.

Thus, the present invention is directed to electron transfer compositions comprising a first matrix and a second matrix. In these compositions, the first matrix is a glassy sugar matrix, and the second matrix contacts the first matrix and is capable of providing electrons to the first matrix.

Any sugar capable of forming a glassy sugar matrix can be used to make any of the glassy sugar matrices described herein. Preferably, the sugar glass comprises trehalose. More preferably, the sugar glass comprises trehalose and sucrose, most preferably at concentrations of approximately 80:20 mg/ml trehalose:sucrose. See Example 1.

The glasses are preferably 1 mm or less in thickness and can be formed into wires or plates for batteries or electrical transmission, for example in semiconductors. The glasses can also be used with photolithographic methods or other methods to make semiconductor chips.

The glass needs to be kept dry, so it is preferably sealed.

The first matrix can further comprise a redox protein that is reduced when the second matrix provides electrons to the first matrix. The redox protein can be any protein capable of undergoing an oxidation-reduction reaction. Nonlimiting examples include metal-containing proteins where the metal can adopt different oxidation states, for example Fe⁺³ hemoproteins. Preferred redox proteins include hemoglobin, myoglobin, cytochrome c, and transferrin.

The second matrix can provide electrons to the first matrix by can serving as a source of electrons that flow into, then out of, the second matrix to the first matrix. Thus, the second matrix can be any electron-conductive material including but not limited to metal wires, semiconductor chips, and sugar glass.

The second matrix can also provide electrons to the first matrix by further comprising an electron donor. Preferred electron donors are reducing sugars. See Examples. Nonlimiting examples of useful electron donors for various purposes are diazaflavin, glucose, tagatose, fructose, a flavin, a flavoprotein, or a metalloprotein in the reduced state. The second matrix can also be a second glassy sugar matrix.

Quantum dots can also be used as an electron donor, particularly in applications where photoelectrons are utilized. A matrix comprising quantum dots could respond to the full spectrum of sunlight and could thus be useful in e.g., solar cells and photo detectors.

Where the second matrix further comprises electron donors, the second matrix preferably provides electrons to the first matrix under a reducing condition. Preferred reducing conditions here are heating of the matrix or exposure of the second matrix to a light, for example sunlight.

As used herein, a reducing condition is any condition that causes the addition of electrons. With the electron transfer compositions disclosed herein, examples of reducing conditions include heating the composition, exposing the composition to light, or subjecting the composition to an electric current. It is understood that heating or exposing to light is a reducing condition for only some compositions, e.g., those having electron donors that release electrons and having a protein that becomes reduced under those conditions.

The first matrix can also, or alternatively, comprise any of the above-described electron donors.

These electron transfer compositions can further comprise a third matrix that contacts the first matrix and is capable of receiving electrons from the first matrix. The third matrix can be any electron-conductive material including but not limited to metal wires, semiconductor chips, and sugar glass. This third matrix can also comprise any of the redox proteins described above. In preferred embodiments, the third matrix is an electrical connection.

The invention is also directed to electron transfer compositions comprising a first matrix and a second matrix. In these compositions, the first matrix is a glassy sugar matrix, and the second matrix contacts the first matrix and is capable of receiving electrons from the first matrix.

The first matrix in these compositions can comprise a redox protein. As with the compositions described above, the redox protein can be any protein capable of undergoing an oxidation-reduction reaction. Nonlimiting examples include metal-containing proteins where the metal can adopt different oxidation states, for example Fe⁺³ hemoproteins. Preferred redox proteins include hemoglobin, myoglobin, cytochrome c, and transferrin.

The first matrix can provide electrons to the second matrix by further comprising an electron donor. Preferred electron donors are reducing sugars. See Example. Nonlimiting examples of useful electron donors for various purposes are diazaflavin, glucose, tagatose, fructose, a flavin, a flavoprotein, or a metalloprotein in the reduced state. The electron donor can also comprise a quantum dot.

Any sugar capable of forming a glassy sugar matrix can be used to make the first matrix here. Preferably, the sugar glass comprises trehalose. More preferably, the sugar glass comprises trehalose and sucrose, most preferably at concentrations of approximately 80:20 mg/ml trehalose:sucrose. See Example.

The second matrix can be any electron-conductive material including but not limited to metal wires, semiconductor chips, and sugar glass. This second matrix can also comprise any of the redox proteins described above. In preferred embodiments, the second matrix is an electrical connection.

When the first matrix further comprises electron donors, the first matrix preferably provides electrons to the second matrix under a reducing condition. Preferred reducing conditions here are heating of the matrix or exposure of the second matrix to a light, for example sunlight.

Additionally, the invention is directed to electric batteries comprising any of the above electron transfer compositions. Preferably, the glassy sugar matrix in these batteries further comprises a redox protein. There, the redox proteins are subjected to reducing conditions, becoming reduced to store the electricity, then oxidized to release the stored electrons.

The invention is further directed to electric circuits comprising any of the above electron transfer compositions. Preferably, the glassy sugar matrix in these circuits further comprises a redox protein.

The invention is additionally directed to semiconductors comprising any of the above electron transfer compositions. Preferably, the glassy sugar matrix in these semiconductors further comprises a redox protein. The semiconductors can be made by any method known in the art, for example photolithographic methods.

Also, the invention is directed to solar cells comprising any of the above electron transfer compositions. Preferably, the glassy sugar matrix in these solar cells further comprises a redox protein, most preferably redox proteins that become reduced on exposure to light (see Example). It is also preferred if the glassy sugar matrix further comprises an electron donor, e.g., a reducing sugar or a quantum dot. More preferably, the glassy sugar matrix further comprises a redox protein and an electron donor.

The invention is also directed to thermal detectors comprising any of the above electron transfer compositions. Preferably, the glassy sugar matrix in these thermal detectors further comprises a redox protein, most preferably redox proteins that become reduced on exposure to heat (see Example).

Further, the invention is directed to photo detectors comprising any of the above electron transfer compositions. Preferably, the glassy sugar matrix in these thermal detectors further comprises a redox protein, most preferably redox proteins that become reduced on exposure to light (see Example). The glassy sugar matrix in these photo detectors can also usefully comprise an electron donor, e.g., a reducing sugar or a quantum dot.

Additionally, the invention is directed to methods of transferring electrons to a redox protein. The methods comprise preparing any of the above compositions, where the composition further comprises a redox protein in the glassy sugar matrix, then subjecting the composition to a reducing condition.

Preferred embodiments of the invention are described in the following Example. Other embodiments within the scope of the claims herein will be apparent to one skilled in the art from consideration of the specification or practice of the invention as disclosed herein. It is intended that the specification, together with the example, be considered exemplary only, with the scope and spirit of the invention being indicated by the claims, which follow the examples.

### EXAMPLE

### Sugar-Derived Glasses Support Thermal and Photo-Initiated Electron Transfer Processes Over Macroscopic Distances

This Example is published in J. Biol. Chem. 281:36021-8.

### Example Summary

Trehalose-derived glasses are shown to support long range electron transfer reactions between spatially well separated donors and protein acceptors. The results indicate that these matrices can be used not only to greatly stabilize protein structures but also to facilitate both thermal and photo-initiated hemeprotein reduction over large macroscopic distances. To date the promise of exciting new protein-based technologies that can harness the exceptional tunability of protein functionality has been significantly thwarted by both intrinsic instability and stringent solvent/environment requirements for the expression of functional properties. The presented results raise the prospect of overcoming these limitations with respect to incorporating redox active proteins into solid state devices such as tunable batteries, switches, and solar cells. The findings also have implications for formulations intended to enhance long term storage of biomaterials, new protein-based synthetic strategies, and biophysical studies of functional intermediates trapped under nonequilibrium conditions. In addition, the study shows that certain sugars such as glucose or tagatose, when added to redox-inactive glassy matrices, can be used as a source of thermal electrons that can be harvested by suitable redox active proteins, raising the prospect of using common sugars as an electron source in solid state thermal fuel cells.

### Introduction

In a preliminary study (Ray et al., 2002) it was shown that doping trehalose glasses containing either methemoglobin or metmyoglobin with glucose (a reducing sugar) resulted in samples that undergo facile thermal reduction. Here, it is demonstrated that not only that such processes are likely to be general but that these glass-facilitated redox reactions can occur over surprisingly large macroscopic distances.

### Experimental Procedures

Materials

Reagents and proteins were all obtained from Sigma with the exception of tagatose (generous gift from Spherix Inc.), deazaflavin (a generous gift of Dr. Bruce Palfey, University of Michigan), myoglobin mutants (generous gifts from Dr. John Olson, Rice University), and oxygenated human adult hemoglobin (a generous gift from Dr. Seetharama Acharya).

### Methods

Thin (1 mm or less) glassy matrices were prepared from stock solutions of either (a) 80:20 mg/ml of trehalose:sucrose or (b) 60:20:20 mg/ml trehalose:sucrose:glucose (or either fructose or tagatose, D-lyxohexulose, a stereoisomer of fructose) in deionized water. The use of the combined trehalose/sucrose protocol over one with just trehalose eliminated the occasional formation of crystals during drying (Dashnau et al., 2005; Wright et al., 2002). The glucose, fructose, and tagatose were introduced as potential sources of thermally generated electrons. The above solutions were mixed with aliquots of stock solution of proteins to achieve concentrations of 0.25 mM in protein. Small aliquots of the resulting solutions were layered on a glass plate, dried in a dessicator for several days, and then warmed at 40° C. for 40 min. The cooled samples were stored in a sealed container at room temperature. For the two-layer sandwich experiments, the protein-containing first layer was prepared by the first method (a). For the thermal-mediated reduction experiments, protocol b without protein was used to generate the second layer. For light-mediated reduction, 10 μl of a deazaflavin solution (0.5 mg/ml in deionized water) was added to protocol b without the addition of protein. Deazaflavin is an effective source of photo-generated electrons (Massey and Hemmerich, 1978). The two extensively dried and preheated glassy layers were then sandwiched together and either heated or illuminated (390-nm light). Subsequent to either the heating or the illumination protocols, the two sandwiched layers were separated. The visible absorption spectrum was then generated from the protein-containing layer and in some cases from a protein solution derived from redissolving the protein-containing glassy layer.

For the long distance photo-electron transfer measurement, glassy matrices were prepared using three different stock solutions as follows; (a) 80 mg of trehalose and 20 mg of sucrose added to and dissolved in 1 ml of a stock solution of 0.1 mM FMN and 0.2 mM NADPH in deionized water; the combination of FMN and NADPH has been shown to be effective in the photo-reduction of hemeproteins in solution (Brunori et al., 2005); (b) 80:20 mg/ml trehalose:sucrose dissolved in 1 ml of deionized water; (c) 80:20 mg/ml trehalose:sucrose dissolved in 1 ml of a 0.2 mM cytochrome c (Fe(III)) solution.

A small aliquot of solution from a and then c were placed separately on the same glass slide separated by 4 cm. These two separated “drops” were dried extensively, yielding well separated uniform glassy matrices. The gap between the separated glasses was then bridged with a thin fast drying strip of the viscous protocol b solution. In one case this glassy linker actually made contact with the two initially prepared glasses, and in the other case silver paste was used to bridge a small residual gap between the ends of glassy linker and the two initially prepared glasses. The drying time of the linker was sufficiently fast to preclude any obvious dissolving of the initially prepared glasses. The FMN/NADPH-containing portion of the sample was selectively illuminated (420 nm).

For thermally initiated long range electron transfer measurements, samples were prepared as in the above photo-initiated measurements except that the protein used was met human adult hemoglobin (HbA), and instead of the FMN/NADPH-doped glass, a tagatose-doped glass (as in method b) was used. The sample was then subjected to heating cycles, and the absorption spectrum of the Hb was recorded after each cycle. The control utilized a tagatose-free glass. In the following sections the designations Glass 1, 2, and 3 are used to indicate that the glass in question has either no added additional sugar (beyond the trehalose/sucrose mixture), added glucose, or added tagatose, respectively.

### Results

Heating in the Absence and Presence of Added Glucose (Glasses 1 and 2)

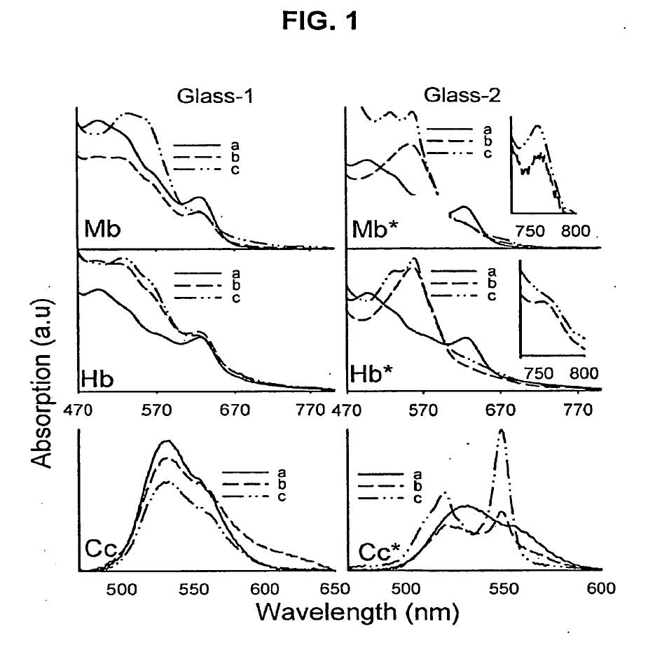

FIG. 1 compares Glass 1 and Glass 2 with respect to the spectral changes occurring when heating glass-embedded oxidized derivatives of horse myoglobin (Mb), human adult hemoglobin (Hb), and cytochrome c (Cc) embedded in a thin glassy layer from a trehalose-sucrose mixture. The panels on the left, labeled Mb, Hb, and Cc, show the progressive changes with heating for a glucose-free glass (Glass 1), whereas the panels on the right, labeled Mb*, Hb*, and Cc*, show the thermal-induced changes for glucose-doped glass (Glass 2). In all cases discussed in this work, the absorption spectra are recorded after the heated sample has cooled back down to ambient temperatures. The initial glassy sample before heating typically manifests the absorption spectrum of the corresponding solution phase sample unless otherwise noted. For Mb and Hb these spectra correspond to the aquomet derivative in which water is the sixth ligand of a high spin ferric heme iron. The spectrum from the ferric Cc sample is characteristic of a six-coordinate low spin ferric heme. In contrast to Hb and Mb, the heme-iron for Cc has a permanent intrinsic sixth ligand derived from a methionine side chain.

The spectra after the heating cycle for the aquomet Mb and Hb samples in the absence of added glucose show no indication of reduction. Although the spectra show no indication of reduction, they do demonstrate the progressive formation of the oxidized six-coordinate derivative of the two proteins known as the hemichrome (Rachmeilwitz et al., 1971). Hemichrome formation, often associated with significant osmotic stress (Ray et al., 2002; Liu et al., 2005), is the result of the imidazole side chain of the distal histidine replacing water as the sixth ligand. Dissolving the glass in aqueous buffer resulted in the full recovery of the standard spectra of the initial aquomet derivatives. The corresponding heat cycling for the glucose-free Cc samples showed no substantive changes in the initial spectrum attributed to the initial oxidized Cc derivative.

In marked contrast to the results obtained for the glucose-free samples, the glucose-containing samples show clear evidence of reduction upon heating. The panels labeled Mb* and Hb* both show that the initial heating cycle results in the loss of the aquomet spectra and the appearance of five coordinate ferrous heme spectra both in the visible region and near IR regions. Continued heating produces a contribution to the spectra from the six-coordinate reduced species known as the hemochrome (Rachmeilwitz et al., 1971), again the result of osmotic stress. Dissolving these hemochrome samples in aerated buffer yields the standard spectra associated with the fully oxygenated derivatives of either Hb or Mb. The Cc* panels show the conversion with heating of the oxidized Cc spectrum to that of the fully reduced Cc spectrum. The reduction of oxidized Cc is observed to occur at substantially lower temperatures than for either Mb or Hb.

Thermal-Mediated Protein Reduction: Sugar Dependence

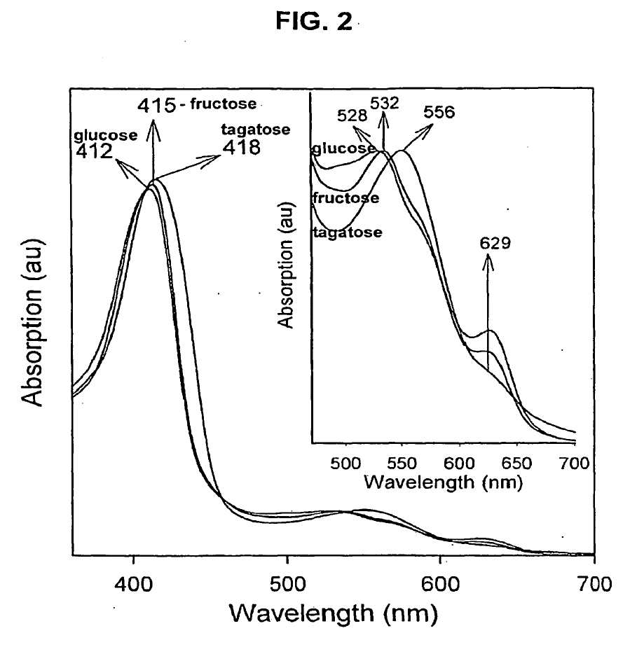

For a given protein and preparative protocol, the thermal reduction profile was highly sensitive to the specific sugar added to the trehalose/sucrose glass. FIG. 2 shows that the degree of reduction for a glass-embedded sample of aquomet HbA heated at 65° C. for 45 min is a function of added sugar to the trehalose/sucrose glass. The three added sugars, all monosaccharides, were glucose, fructose, and tagatose. The extent of reduction as reflected in the appearance of deoxy spectral features increases in going from glucose to fructose to tagatose. When tagatose was added to a ferric Cc-containing glass (Glass 3), extensive reduction was fully apparent upon drying, even at ambient temperatures without any heat cycling (not shown).

Sugar-Mediated Thermal Reduction of Mb Does Not Require Either a Distal Histidine or a Sixth Ligand

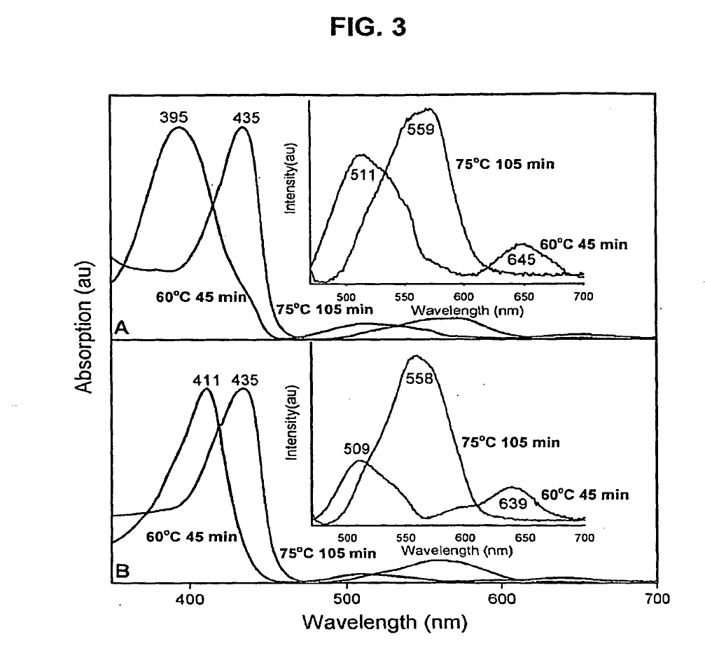

FIG. 3 shows that glucose-mediated thermal reduction occurs for two Mb mutants that have distal histidine (His-64) replacements. In FIG. 3, panel A, the thermal reduction of Mb(H64L) is shown. The H64L mutation resulted in the introduction of a nonpolar side chain in lieu of the polar imidazole side chain of the histidine. This replacement resulted in a water-free distal heme pocket, and as a result the met derivative is a five-coordinate high spin species as reflected in the Soret band at 395 nm. As can be seen in the figure, the heating cycle generates a species with an absorption spectrum characteristic of a deoxy derivative. The position of Band III for this species is at 767 nm (not shown), a value characteristic of a deoxy Mb with a relatively nonpolar/water-free distal heme pocket (Christian et al., 1997). The end point spectrum after the heating cycles is virtually identical to that of the solution phase deoxy sample of this mutant (not shown). The panel shows a similar thermal reduction pattern for the Mb(H64Q) mutant. Here the mutation replaces the imidazole-sided chain with another polar side chain but without the potential redox-mediating capacity of the imidazole. The spectra are consistent with water being present in the met derivative. The position of Band III (not shown) for the end point deoxy species is 760 nm, a value consistent with a water-containing distal heme pocket.

Glass Composition Dependence of the Thermal Reduction Process

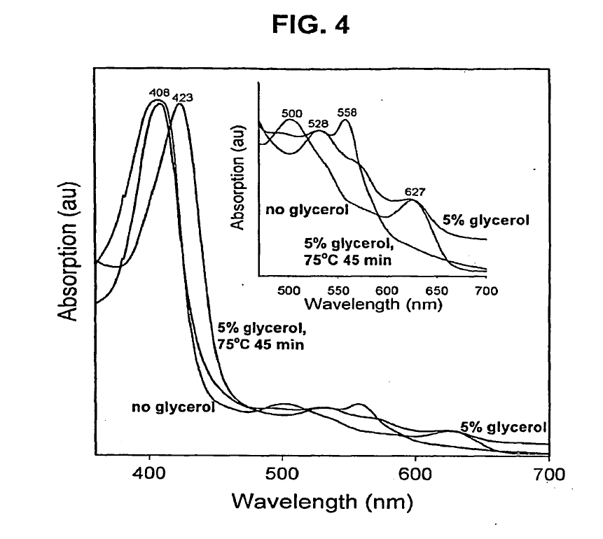

FIG. 4 shows the influence of doping an HbA-containing Glass 2 with 5% by volume glycerol (no preheating). In contrast to the glycerol-free Glass 2 sample, which manifests the unaltered aquomet HbA spectrum, the initial spectrum of the glycerol-doped samples at ambient temperature is characteristic of the hemichrome formn of HbA. Subsequent to a 45-min 75° C. heating cycle, the glycerol-doped sample had undergone nearly complete reduction, but the resulting species was the hemochrome derivative, in contrast to the five-coordinate deoxy derivative that was generated using a comparable glycerol-free Glass 2 sample subjected to a similar heating cycle. Preliminary results with chitosan-doped trehalose/sucrose glasses (made from 12.5 mg of chitosan dissolved in 1 ml of the trehalose/sucrose starting solution) showed a similar enhancement in the formation of the hemichrome; however, the chitosan also reduced the threshold for thermal reduction, i.e. reduction occurred at lower temperatures when compared with the corresponding chitosan-free sample. The addition of polyvinyl alcohol to the glass samples enhanced the flexibility of the glass but eliminated the thermal reduction capabilities of the resulting glass. A thin aquomet Hb-containing tetramethoxysilane-derived porous sol-gel sample was also fully bathed in an excess of the Glass 2 starting solution. After allowing the sample to sit for several days then pouring off the excess solution and allowing the sample to thoroughly dry, a visually glassy sample was obtained that still manifested the starting aquomet HbA spectrum. Repeated heating cycles similar to those described above did not result in any observed sample reduction; however, with heating the spectrum of the sample rapidly converted to and remained that of the hemichrome. Soaking the sample in an excess of N₂-purged buffer did not reverse the hemichrome spectrum; however, subsequent addition of a reducing agent (dithionite) and CO to the buffer resulted in a ferrous CO Hb spectrum for the encapsulated HbA.

Trehalose/Sucrose Glass Supports Photo-Initiated Hemeprotein Reduction at Ambient Temperatures

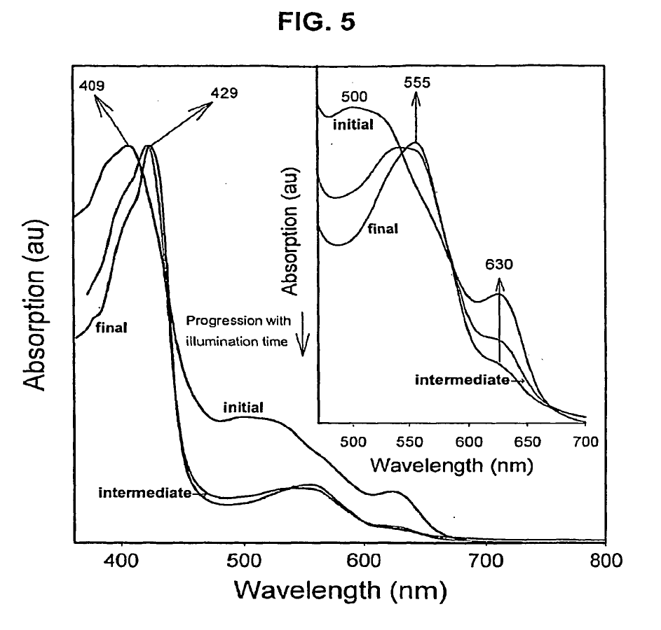

The above results all show that the monosaccharide-doped trehalose/sucrose glasses support thermally initiated hemeprotein reduction. FIG. 5 shows that photo-generated electrons within the glass at ambient temperatures are also effective in reducing embedded hemeproteins. The shown spectra are from aquomet HbA embedded in a deazaflavin-doped Glass 3. Similar results were obtained with a deazaflavin-doped Glass 1, but the extent of reduction as a function of illumination time was more extensive for the Glass 3 sample. The figure shows the initial met Hb spectrum being converted to the deoxy Hb spectrum with continued illumination. Without deazaflavin there is no reduction under these illumination conditions (excitation at 390 nm); however, illumination in the absence of the deazaflavin with 280-290 nm light does result in progressive reduction of the met Hb sample, which is likely the result of the direct tryptophan excitation (Sakai et al., 2000).

Electron Transfer in Two-layer Glassy Sandwiches

The above results clearly show that sugar-derived glasses can support both thermal and photo-initiated redox processes. In those single film experiments it is not clear to what extent the electron donor and acceptor are physically separated. In the two-layer sandwich experiments the donor and acceptor are in separate dry films. These two-layer experiments also address the question of whether the monosaccharide-dependent differences in thermal reduction efficiency arise from differences in the physical properties of the different monosaccharide doped glasses as a function of temperature or from differences in the ability of these sugars to generate thermal electrons.

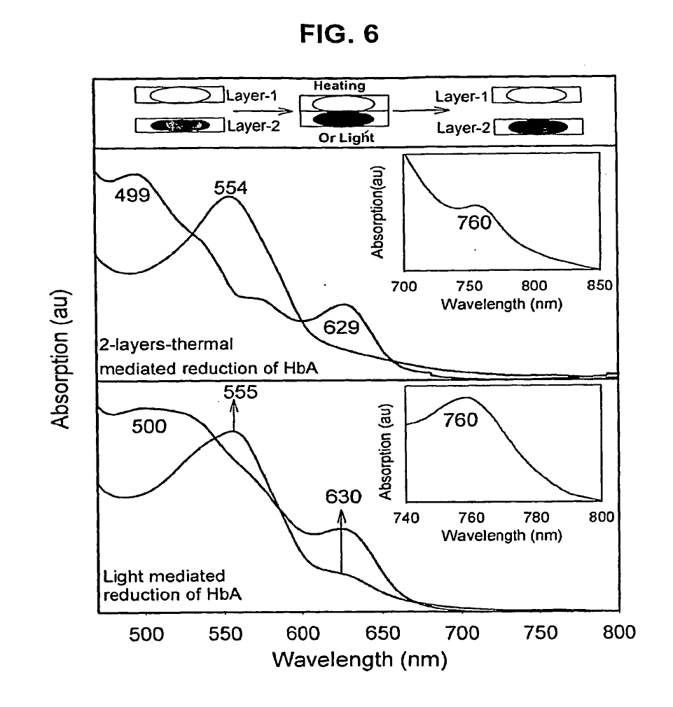

FIG. 6 shows both a schematic for the two-layer protocol and results from two different sandwich experiments. In both these and all the other two-layer experiments, the two layers were separated subsequent to the heating cycle before the absorption measurements. In all cases there was no visual evidence of mixing of the two dry glasses as reflected in the absence of any heme-associated red coloring in the protein-free layer.

The FIG. 6 top panel below the schematic shows results from a two-layer thermal reduction experiment. An aquomet HbA-containing trehalose/sucrose layer was sandwiched with a second protein-free glassy layer containing tagatose as a dopant (60:20:20 mg/ml trehalose:sucrose:tagatose in deionized water). The sandwich was heated at 75° C. for 45 min, and then the two layers were separated once the sample cooled to ambient temperature. The figure shows that with heating of the sandwich, the initial aquomet HbA spectrum (black curve) converted to the spectrum (red curve) associated with the reduced high spin form of HbA (often referred to as deoxy-HbA). The appearance as well of the near infrared absorption band at 760 nm, associated only with the reduced deoxy derivative, is also shown in the inset. Dissolving the Hb-containing sample under atmospheric conditions yields a sample that manifest the spectrum associated with the standard oxygenated ferrous derivative of HbA. As previously reported for the single layer trehalose experiments (Ray et al., 2002), when the protein-free layer was derived exclusively from the trehalose/sucrose mixture, the only heat-induced spectral changes are those associated with the formation of the hemichrome.

The bottom panel of FIG. 6 shows an analogous sandwich experiment but with photo electrons instead of thermal electrons being the source of the protein reduction. In this case the protein-free layer was lightly doped with deazaflavin (10 μl of 0.5 mg/ml stock of deazaflavin in deionized water added to the 1 ml of solution containing trehalose and sucrose), and the sandwich was illuminated with spectrally isolated (using a filter) 390-nm light at ambient temperature for approximately 2 h. The figure shows that after the illumination cycle the protein-containing layer had undergone changes, indicating significant reduction of the initial aquomet HbA sample. Similar results were obtained for ferric cytochrome c and aquomet Mb. Control single or double layer samples that were without deazaflavin did not show any changes in the spectrum of the initial ferric derivatives after illumination at 390 nm. FMN/NADPH-doped glasses were not as effective as deazaflavin with respect to complete reduction of Hb or Mb samples.

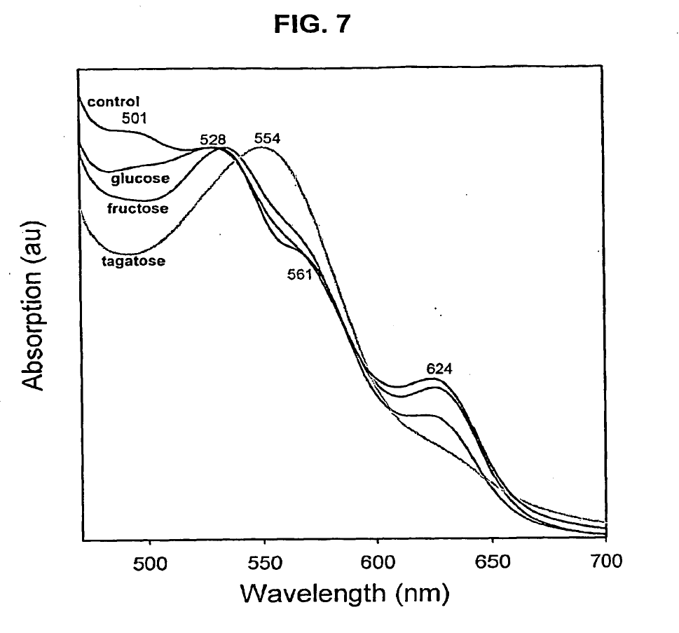

FIG. 7 shows the resulting spectra for four met HbA two-layer sandwich samples that have been subjected to the identical heating cycle (70° C. for 1 h). In each case the Hb-containing layer is a Glass 1 sample, and the protein-free layer is a trehalose/sucrose glass that is varied with respect to added monosaccharides (control with only trehalose/sucrose, glucose, fructose, tagatose). The extent of reduction follows the same pattern as seen for the single layer samples. The extent of reduction again increased in the progression control (trehalose/sucrose with no other added sugar)<<glucose<fructose<tagatose.

Electron Transfer Between Macroscopically Separated Proteins

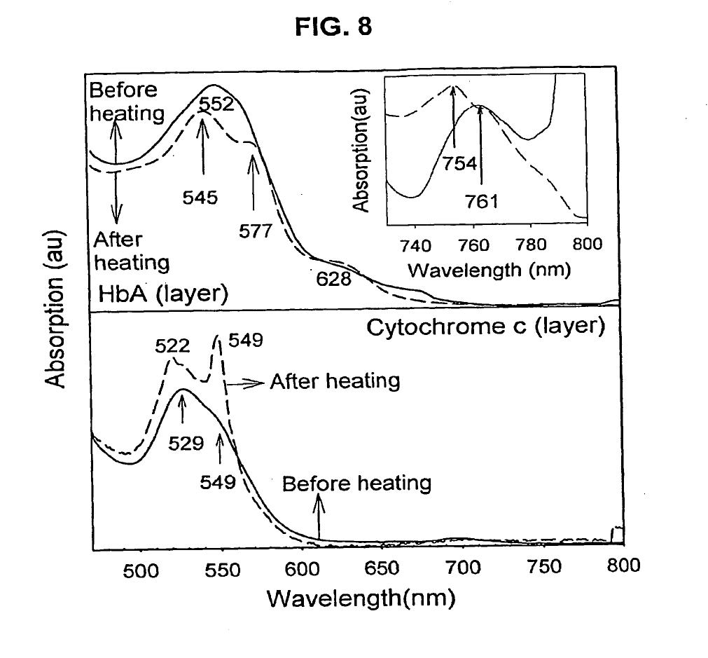

The single and double layer experiments show electron transfer to proteins from either sugars or flavins. These results indicate that the glass matrices should also support interprotein redox reactions. FIG. 8 shows the spectra of the individual layers comprising a two-layer sandwich consisting of a deoxy-HbA Glass 1 layer and an Fe(III) Cc Glass 1 layer both before and after heating (50° C. for 45 min) the two-layer sandwich. Before heating, the spectra were consistent with the HbA and Cc samples being in the reduced and oxidized states, respectively. The redox status of the samples reversed subsequent to the heating cycle. The Cc spectrum was then clearly that of the reduced derivative, and that of the HbA sample resembled that of the hydroxyl met derivative. The results were consistent with thermal-mediated electron transfer from the HbA sample to the Cc sample as would be anticipated based on the latter having the known higher redox potential.

Very Long Range Electron Transfer Within Glassy Matrices

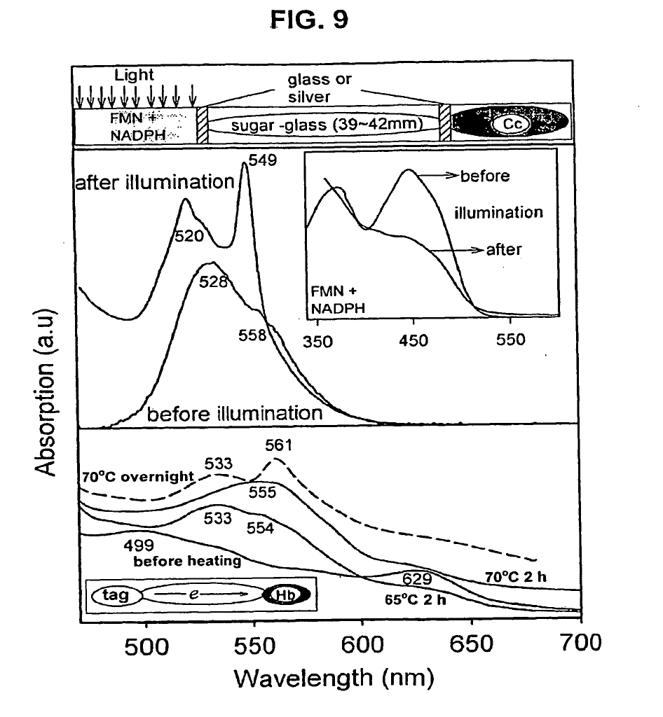

A more dramatic illustration of the capacity of the glassy matrices to support electron transfer was obtained using a protocol where a glass containing the electron source and a second well separated (40 mm) glass containing the protein electron acceptor were physically linked by a strip of glass that was free of either the addition of added sugars or protein (Glass 1). FIG. 9 shows a schematic of the physical arrangement and the results obtained for a heat cycling protocol utilizing met HbA and tagatose as the physically separated but linked electron acceptor and thermal electron source, respectively. With continued heating the HbA spectrum showed at first the transition from the aquomet to the hemichrome species followed by reduction to the deoxy derivative and finally with continued heating to the hemochrome species. No reduction was observed if a dopant-free protocol a glass was used instead of the tagatose-containing glass. FIG. 9 illustrates that the glass also supported long distance electron transfer at ambient temperatures by using photoelectrons as the electron source. In this case localized illumination at ambient temperatures of an electron-source glass containing a combination of FMN and NADPH was used to initiate the electron transfer process. Upon initiating the illumination protocol, there was an almost immediate visual change in the color of the protein-containing segment. The absorption spectrum confirmed the occurrence of the reduction process. Two protocols were tested with comparable results. In one case the glass linker made actual contact with the two initially prepared separated matrices. In the other case the glass linker was allowed to form without directly contacting the Cc and FMN-containing matrices. Once the linker glass formed (after drying), the links to the Cc- and FMN-containing glasses were then created with silver paint. In both cases illumination of the FMN-containing matrix resulted in the well separated Cc-containing matrix immediately turning red on the time scale of visual observation. The figure illustrates the result for Cc where complete reduction occurs. The use of met HbA as an electron acceptor resulted in partial reduction and eventual reversal of the spectrum back to the met derivative. In single-composite-layer or two-layer sandwich experiments, the use of deazaflavin as a source of photoelectrons proved much more effective in photo-reducing all three proteins compared with the FMN/NADPH mixture. Limited supplies of deazaflavin precluded its use in the long distance experiments.

### Discussion

The above results show that glassy matrices derived from sugars can support long distance electron transfer reactions between redox active proteins and either thermal or photo electron sources. There are several possible mechanisms for the long range electron transfer. One possibility is that transport is through electron hopping via the extended proton-oxygen hydrogen bonding network that is characteristic of sugar-derived glasses. It is envisioned that the glass, with respect to electron diffusion, has a potential energy surface comprised of numerous shallow potential minima associated with each hopping site within the network. The absence of any deep potential minima allows for extended hopping through the network. The embedded proteins contribute deep minima traps for the hopping electrons. Thus, the electron transfer process becomes an entropic search over a large energy landscape characterized by numerous shallow wells and an occasional deep trap. Mobile waters do not appear to be the vehicle for electron transfer since the process is enhanced for the drier samples. Drying of sugar-glasses has been shown to decrease the fraction of mobile waters, i.e. waters not integrated into the relatively rigid hydrogen-bonding network (Dashnau et al., 2005; Wright et al., 2003; Abbruzzetti et al., 2005; Cordone et al., 2005, Librizzi ct al., 1999). This hopping model would allow for electron or proton transport to occur not via the individual initially generated electrons/protons hopping from source to sink but by having the extended hydrogen-bonding network to propagate the successive uptake and release of the charges along the hydrogen-bonded network. An electron/proton that is transiently taken up at one end of a given long chain member of the hydrogen-bonding network could trigger an electron/proton release at the other end of the chain. This process is analogous to the Grotthuss mechanism (Agmon, 2006), which accounts for the much faster overall conduction of protons compared with other small ions in water. As in the water-wire model, the electron or proton can rapidly shuttle among the numerous linked hydrogen-bonded oxygens. As a result the transport of the electron/proton does not require the large amplitude displacement of molecular species for either the electron/proton or a mobile charge-carrying molecular species to diffuse from one site to another. It is, however, quite probable that the electron/proton hopping along the hydrogen-bonded network within the glass is activated via low frequency fluctuations of the vibration modes of the coupled network comprising the glass. These thermal fluctuations would facilitate the hopping from one shallow minimum to another.

The ability to support long range electron transfer is likely to be general with respect to polysaccharide-derived glasses based on preliminary results showing similar phenomena in glasses derived from chitosan- and glycerol-doped glasses. How and by what mechanism additives to the glass recipe impact electron transfer properties is unclear. One possibility is that additives such as chitosan provide added long chain “wires” that facilitate the hopping process. The absence of thermal-mediated redox activity for the PVA-doped glass and the sol-gel sample may stem from an absence of the necessary extended hydrogen-bonding networks. Additives such as glycerol when present in the right amount could displace mobile waters and act as a hydrogen-bonding linker among discrete clusters of hydrogen-bonded sugars and, thus, extend the network.

Sugar and Protein Dependence

The heat cycling experiments show that sugar-derived glassy matrices support long distance electron transfer under conditions where sugars can function as a thermal source of electrons and suitable proteins can function as harvesters of the sugar-derived electrons. The single and two-layer experiments show that the efficacy of thermal generation of electrons is sugar-dependent, ranging from trehalose and sucrose with essentially no activity to increasing activity in the following progression: glucose, fructose, and tagatose. The observation of this progression in both the single and two-layer experiments supports the hypothesis that it is the thermal-mediated electron donating properties of the glass-embedded sugars and not their impact on the glass properties per se that is responsible for the effect. The presented results also indicate that the electron-harvesting capacity of the embedded protein is also protein-specific. The limited data set suggests that this harvesting capacity scales with the redox potential. Oxidized Cc, which has a significantly higher redox potential than either met HbA or met Mb, undergoes thermal reduction at lower temperatures when compared with both of these other two proteins under identical conditions.

Biophysical Implications

The finding of long range electron-mediated redox activity in sugar glasses has biophysical implications and applications. On a biological/biophysical level, polysaccharide-derived hydrogen-bonding networks are likely to form in those biological systems that manifest anhydrobiosis. The present observations suggest that redox activity may be operative in such systems. Redox activity in these seemingly dormant systems may be important for low level intracellular signaling and for maintaining the average redox state of the composite system over an extended time period by minimizing autoxidation.

The reported phenomenon clearly has considerable potential as a biophysical tool. Not only do these biological systems present with novel electronic properties requiring further exploration of the nature of long range electron hopping mechanism, but they also provide a means of changing the redox state of proteins without conformational reorganization (due to the coupling of the protein to the rigid hydrogen bonding network of the trehalose glass). Thus, the rigid sugar matrix allows for the investigating of redox processes under conditions where is no reorganization energy issue (Hoffman et al., 2005). The glassy matrix, by virtue of the near complete damping of conformational dynamics coupled to the mobility of surface waters, allows for the trapping and spectroscopic probing of functional intermediates under nonequilibrium conditions. For example the glass-facilitated reduction of the R state met derivative of HbA results in the production of a metastable deoxy-R state form of HbA. Similarly, this approach should yield ferrous cytochromes that retain the conformational distribution of the equilibrium population of the initial ferric species.

Implications for Technology

The finding that sugar-derived glasses support long range electron transfer is likely to be important in developing new electronic technologies (Gray and Winkler, 2005). Perhaps most significant is that the above findings clearly raise the prospect of interfacing proteins with solid state devices. The glass confers conformational stability to embedded proteins under conditions where redox reactions still occur. In particular these results show that glass-stabilized redox proteins can be used to efficiently harvest electrons generated by either thermal or photo-initiated processes. Given the combination of these properties and the ease with which redox properties can be bio-engineered and optically modulated in redox center-containing proteins, it would appear that glass-embedded proteins represent an especially promising platform for harnessing the redox properties of proteins for use in robust solid state electronic and electro-optical devices. In addition, there are unique new opportunities for redox-based synthetic strategies. The glass traps the initial distribution of structures, not allowing the entering of new substrates or escaping of products from the protein. Thus, the glass provides a platform for conducting redox chemistry on very well defined initially prepared and trapped species without the prospect of complex secondary reactions. The oxidized heme and the substrate-containing distal heme pocket of the hemeprotein now become a very well defined synthetic chamber with respect to reduction-initiated chemistry.

There have been schemes proposed and explored for using glucose as a source of usable electrons (Chaudhuri and Lovley, 2003). These approaches are based on enzymatic reactions requiring aqueous environments whereas the present study indicates that glucose, fructose, or tagatose embedded in a solid glass matrix can be used to generate thermal electrons that are readily harvested by suitable redox active proteins. Thus, the combined addition of glucose (or fructose or tagatose) and a suitable electron harvesting protein into a glass matrix could provide the basis for robust thermal charging batteries. The current results suggest that such systems would be very efficient, with the proteins harvesting most of the thermally produced electrons (as well as photogenerated electrons for systems doped with a source of photoelectrons). Properties of the battery such as the charging temperature and the resulting voltage would be easily tuned by choice of sugar and redox protein.

Trehalose glass, because of its protein-stabilizing properties, is the basis for many powder formulations for protein and peptide-based pharmaceuticals (Crowe et al., 1996; D'Alfonso et al., 2003; Garzon-Rodriguez et al., 2004; Heller et al., 1999; Newman et al., 1993). These formulations have a finite shelf life that is not readily explained given the stabilizing properties of the glass. The present study shows that these matrices are not inert. Trace amounts of reducing sugars in such materials can supply electrons that can ultimately find a suitable redox center within the glass. Similarly, one can anticipate thermally initiated long range electron transfer reactions between any two redox centers having appropriately different redox potentials. The design of sugar-glass-derived glassy matrices for use in long term storage of pharmaceuticals and food products must take into account this new redox capacity of the glass especially as a potential means of minimizing oxidative damage.

### REFERENCES CITED

Abbruzzetti, S., Giuffrida, S., Sottini, S., Viappiani, C., and Cordone, L. Cell Biochem Biophys 43, 431-437 (2005).

Agmon, N. J Phys. Chem. A 109, 13-35 (2005).
Arguelles, J. C. Physiological roles of trehalose in bacteria and yeasts: a comparative analysis. Arch Microbiol 174, 217-24. (2000).
Brunori, M., Giuffre, A., Nienhaus, K., Nienhaus, G. U., Scandurra, F. M., and Vallone, B. Proc Natl Acad Sci USA 102, 8483-8488 (2005).
Chaudhuri, S. K. and Lovley, D. R. Electricity generation by direct oxidation of glucose in mediatorless microbial fuel cells. Nature Biotechnology 21, 1229-32 (2003).
Christian, J. F., Unno, M., Sage, J. T., Champion, P. M., Chien, E., and Sligar, S. G. Biochemistry 36, 11198-11204 (1997).
Cordone, L. et al. A reduction of protein specific motions in co-ligated myoglobin embedded in a trehalose glass. European Biophysics Journal with Biophysics Letters 27, 173-176 (1998).
Cordone, L., Cottone, G., Giuffrida, S., Palazzo, G., Venturoli, G., and Viappiani, C. Biochim Biophys Acta 1749, 252-281 (2005).
Crowe, J. H., F. A. Hoekstra, and L. M. Crowe. Ann. Rev. Physiol. Anhydrobiosis. 54, 579-599 (1992).
Crowe, J. H., Carpenter, J. F. & Crowe, L. M. THE ROLE OF VITRIFICATION IN ANHYDROBIOSIS. Annu. Rev. Physiol. 60, 73-103 (1998).
Crowe L. M., D. S. Reid, J. H. Crowe. Is trehalose special for preserving dry biomaterials? Biophys J 71, 2087 -2093 (1996).
D'Alfonso, L., Collini, M. & Baldini, G. Trehalose influence on beta-lactoglobulin stability and hydration by time resolved fluorescence. Eur J Biochem 270, 2497-504 (2003).
Dantsker, D., Samuni, U., Friedman, J. M. & Agmon, N. A hierarchy of functionally important relaxations within myoglobin based on solvent effects, mutations and kinetic model. Biochim Biophys Acta 1749, 234-51 (2005).
Dashnau, J. L., Zelent, B., and Vanderkooi, J. M. Biophys Chem 114, 71-83 (2005).
Davis, J. J. Molecular bioelectronics. Philos Transact A Math Phys Eng Sci 361, 2807-25 (2003).
Garzon-Rodriguez, W. et al. Optimizing storage stability of lyophilized recombinant human interleukin-11 with disaccharide/hydroxyethyl starch mixtures. J Pharm Sci 93, 684-96 (2004).
Gopel, W. & Heiduschka, P. Introduction to bioelectronics: “interfacing biology with electronics”. Biosens Bioelectron 9, iii-xiii (1994).
Gottfried, D. et al. Evidence for Damped Hemoglobin Dynamics in a Room Temperature Trehalose Glass. J. Phys. Chem. 100, 12034-12042 (1996).
Gray, H. B. & Winkler, J. R. Long-range electron transfer. Proc Natl Acad Sci USA 102, 3534-9 (2005).
Hagen, S. J., Hofrichter, J. & Eaton, W. A. Protein reaction kinetics in a room-temperature glass. Science 269, 959-62 (1995).
Heller, M. C., Carpenter, J. F. & Randolph, T. W. Protein formulation and lyophilization cycle design: prevention of damage due to freeze-concentration induced phase separation. Biotechnol Bioeng 63, 166-74 (1999).
Hoffman, B. M. et al. Differential influence of dynamic processes on forward and reverse electron transfer across a protein-protein interface. Proc Noal Acad Sci USA 102, 3564-9 (2005).
Massey, V. & Hemmerich, P. Photoreduction of flavoproteins and other biological compounds catalyzed by deazaflavins. Biochemistry 17, 9-16 (1978).
Librizzi, F., Vitrano, E., and Cordone, L. Biophys J 76, 2727-2734 (1999).
Liu, W., Guo, X., and Guo, R. Int J Biol Macromol 37, 232-238 (2005).
Lovley, S. K. C. D. R. Nature Biotechnology 21, 1229-1232 (2003).
Newman, Y. M., Ring, S. G. & Colaco, C. The role of trehalose and other carbohydrates in biopreservation. Biotechnol Genet Eng Rev 11, 263-94 (1993).
Rachmilewitz, E. A., Peisach, J., and Blumberg, W. E. J Biol Chem 246, 3356-3366 (1971).
Ray, A., Friedman, B. A. & Friedman, J. M. Trehalose glass-facilitated thermal reduction of metmyoglobin and methemoglobin. J Am Chem Soc 124, 7270-1 (2002).
Sakai, H., Onuma, H., Umeyama, M., Takeoka, S., and Tsuchida, E. Biochemistry 39, 14595-14602 (2000).
Sastry, G. M. & Agmon, N. Trehalose prevents myoglobin collapse and preserves its internal mobility. Biochemistry 36, 7097-108 (1997).
Willner, I. & Willner, B. Biomaterials integrated with electronic elements: en route to bioelectronics. Trends Biotechnol 19, 222-30. (2001).
Wright, W. W., Carlos Baez, J., and Vanderkooi, J. M. Anal Biochem 307, 167-172 (2002).
Wright, W. W., Guffanti, G. T., and Vanderkooi, J. M. Biophys J 85, 1980-1995 (2003).

In view of the above, it will be seen that the several advantages of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

1. The electron transfer composition of claim 55, wherein the second matrix is capable of providing electrons to the first matrix.

2. The electron transfer composition of claim 55, wherein the first matrix further comprises a redox protein.

3. The electron transfer composition of claim 2, wherein the redox protein is a metal-containing protein where the metal can adopt different oxidation states.

4. The electron transfer composition of claim 2, wherein the redox protein is an Fe⁺³ hemoprotein.

5. The electron transfer composition of claim 2, wherein the redox protein is hemoglobin, myoglobin, cytochrome c, or transferrin.

6. The electron transfer composition of claim 55, wherein the second matrix is an electrical connection.

7. The electron transfer composition of claim 55, wherein the matrix providing electrons comprises an electron donor.

8. The electron transfer composition of claim 7, wherein the electron donor is a reducing sugar.

9. The electron transfer composition of claim 7, wherein the electron donor is diazaflavin, glucose, tagatose, fructose, a flavin, a flavoprotein, or a metalloprotein in the reduced state.

10. The electron transfer composition of claim 7, wherein the electron donor is a quantum dot.

11. The electron transfer composition of claim 55, wherein the glassy sugar matrix comprises trehalose.

12. The electron transfer composition of claim 55, wherein the glassy sugar matrix comprises trehalose and sucrose.

13. The electron transfer composition of claim 12, wherein the trehalose and sucrose in the glassy sugar matrix is at a ratio of about 80:20 mg/ml.

14. The electron transfer composition of claim 55, wherein the second matrix is a second glassy sugar matrix.

15. The electron transfer composition of claim 55, wherein the second matrix provides electrons to the first matrix under a reducing condition or wherein the first matrix provides electrons to the second matrix under a reducing condition.

16. The electron transfer composition of claim 15, wherein the reducing condition is the heating of the second matrix.

17. The electron transfer composition of claim 15, wherein the reducing condition is exposure of the second matrix to a light.

18. The electron transfer composition of claim 17, wherein the light is sunlight.

19. The electron transfer composition of claim 1, further comprising a third matrix that contacts the first matrix and is capable of receiving electrons from the first matrix.

20. The electron transfer composition of claim 19, wherein the third matrix is an electrical connection.

21. The electron transfer composition of claim 55, wherein the second matrix is capable of receiving electrons from the first matrix.

22-38. (canceled)

39. An electric battery, an electric circuit, a semiconductor, a solar cell, a thermal detector or a photo detector comprising the electron transfer composition of claim 55.

40-53. (canceled)

54. A method of transferring electrons to a redox protein, the method comprising preparing the composition of claim 55, wherein the composition further comprises a redox protein in the glassy sugar matrix, then subjecting the composition to a reducing condition.

55. An electron transfer composition comprising a first matrix and a second matrix,
wherein the first matrix is a glassy sugar matrix and the second matrix contacts the first matrix, and
wherein the second matrix is capable of providing electrons to the first matrix or the second matrix is capable of receiving electrons from the first matrix.
